(19) United States
(12) Patent Application Publication
(10) Pub. No.: US 2012/0110855 A1
(43) Pub. Date: May 10, 2012

(54) Hair trimmer

(75) Inventor: Keith Allen, SR., Victorville, CA (US)

(73) Assignee: Mr. Keith Allen, SR., Victorville, CA (US)

(21) Appl. No.: 13/200,596

(22) Filed: Sep. 27, 2011

Related U.S. Application Data
(60) Provisional application No. 61/394,578, filed on Oct. 19, 2010.

(51) Int. Cl. B26B 19/38; B26B 19/14; B26B 19/00

(52) U.S. Cl. 30/43.6; 30/526; 30/527; 30/42

(57) ABSTRACT

A trimmer/edger/designer that has different size circular razor pads that rotates the cutting apparatus inside the razor-blade safety guard, at the head of the trimmer. A small razor pad that is capable of getting into tight complicated areas of the face easier. The trimmer/edger/designer has more agility to move around the curves and indentations on the face while keeping the parts of the beard, mustache and around the ear intact.

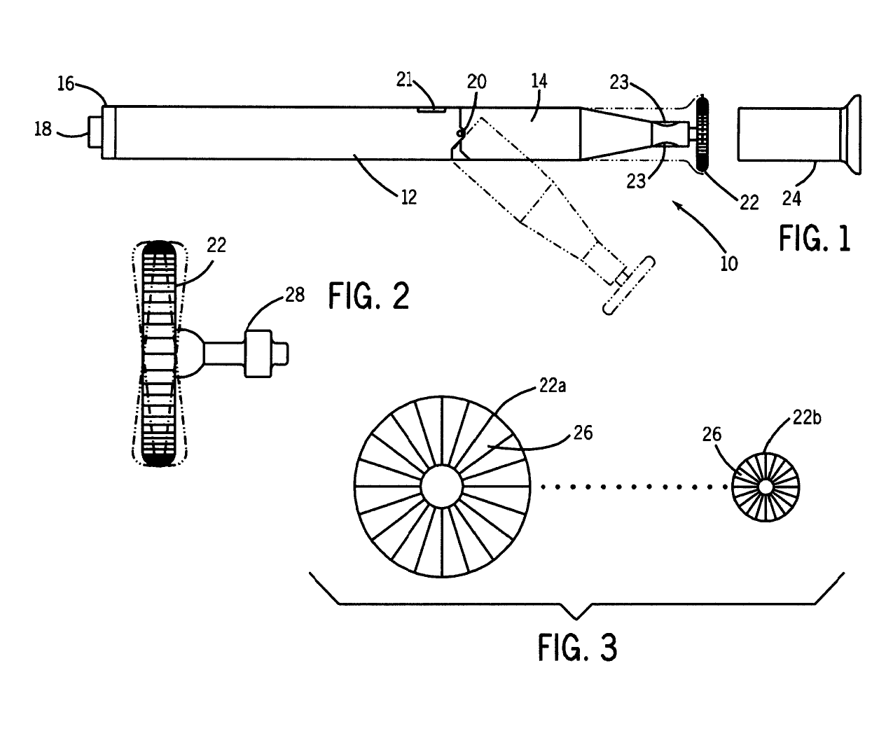

This application claims domestic benefits of provisional application No. 61/394,578. The present invention relates to a hair trimmer that is capable of making delicate and precise cuts and designs in one's hair.

The device is comprised of the following

(1) The trimmer/edger/designer's housing is a slender cylinder about 7.5 inches in length and 1.5 cm in width, that narrows at the end, like the shape of a pencil. The cylinder is a hard plastic or non-electrical conductive material. The top part of the narrow end has a hole in the end where razor-blade heads can be removed or replaced with the razor-blade head that's needed for a particular function. (2) A pivot mechanism is about 2.5 inches from the narrow top of the cylinder. A spring switch is on top of the cylinder, that controls the pivot mechanism, that releases the cylinder to pivot in one direction from 90-180 degrees. The spring switch, also, allows the pivot mechanism to pivot in different degrees between 90-180 degrees. (3) A detachable razor-blade head guard (optional) can be attached to an indentation that has a circumference around the outside of the cylinder that can attach a plastic guard from the indentation that is about 1.25 inches from the narrow end of the cylinder, just under the razor-blade head when placed in the hole designated for the blade head. (4) A on-off push button is at the bottom of the opposite end of the narrow end of the cylinder. (5) A twist cap, which incorporates the on-off push button, is at the bottom end of the cylinder. (6) There are, also, pivoting razor-blade heads . . . starting from small heads where there circumference is 0.25 cm round . . . to pivoting razor-blade heads that has a circumference of 2 cm, and different sizes in between. The razor-blade heads is in a circular configuration that has a safe guard over the razor blade, itself, to allow only the hairs, that are to be trimmed off, inside the slots provided for where the razor blade resides. (7) There are two release buttons on the nose of the narrow end of the cylinder.

All parts of the razor/trimmer/edger/designer are relevant to the design. However, the power source can be configured so it can be plugged into an outlet for a source of power. Also, a variable speed control could be added to control the speed of the blade from high to low and vice versa. The detachable plastic guard is great when a person is cut-drawing in the hair, like using a pencil. Or when you want to have the razor-blade head flat against your head or face, or going around the ears.

The trimmer/edger/designer's housing is sleek, like a pencil, for comfort and control. The bottom 5 inches of the cylinder holds the batteries or power source that generates the power to make the motor turn which turns the razor blade at a high speed. The twist cap holds the power source in place inside the cylinder. The twist cap is incorporated together with the power supply's on-off push button. The other 2.5 inches of the housing's cylinder is the pivoting part of the cylinder that locks into place, and can pivot down to a right angle (90 degrees), up to a straight angle cylinder (180 degrees), or any other angle in between 90-180 degrees. The top 2.5 inches of the cylinder also holds the miniature motor that turns the razor blade at a high speed inside the safe guard that allows only the hairs to be cut threw. At the top narrow end of the pivoting part of the trimmer is two push release buttons on the nose that, push simultaneously, releases the razor-blade head from the hole that holds the blade head in place. An optional detachable plastic guard can be placed on the nose of the narrow end of the pivoting part of the designer to add a more comforting grip, like a pencil, when you are cut-drawing in the hair.

To operate, the on-off push button at the end of the designer is pushed once to close the circuit to start power flowing from the power source that is located inside the cylinder of the lower part of the trimmer. Current immediately causes the motor to turn the blade inside the blade head at a rapid pace. A person can pivot the upper part of the trimmer from 90-180 degrees for a more comfortable and precise trimming, edging, or designing position to cut. To turn off the designer, push the on-off push button once to open the circuit to stop the flow of power. In the off position, a person can change the razor-blade head size by simultaneously pushing the release buttons and pulling out the razor-blade head and then putting in the desire size of razor-blade head.

My invention can be made with a circular razor-blade head, a miniature motor to turn the razor blade inside the head, a power source that is connected to the motor with wires that delivers enough power to turn the motor at an acceptable speed, and an on-off button. All of these components, except the razor-blade head, is put together and contained in a non-electrical conducting container.

The on-off push button at the end of the trimmer/designer can be replaced with an on-off switch that can be placed on the side of the lower part of the cylinder.

To use my invention, a person needs to know what ending result they want to accomplish with the trimmer/designer . . . then pick the correct razor-blade head to carry out that function. For example, if you wanted to edge up your hair line just pick a small razor-blade head. Push the on-off button to turn the edger on. Place the head flat on the part to be edged, like you were about to write with a pencil, and just go straight across. Because the razor blade is rotating so fast you will get a perfectly straight edging. Another example; if you wanted to trim up your mustache from your top lip you can pivot the trimmer slightly and then use the edge of the razor-blade head and edge the hairs off your lip in one consistent stroke. You can, also, use other size razor-blade heads . . . bring the designer to a straight angle, to make it simulate a pencil, and cut-design different shapes, lines, and/or words in your hair with little effort but precise cutting.

My apparatus is a more easier, faster, and convenient way to use a razor/trimmer/edger. In fact, now you can easily draw designs and lines in your head much easier and precisely . . . just like some of the designs that celebrities and sports figures have in their heads.

The conventional trimmers are one dimensional. The cutting head is just in a straight line with teeth so there is no room for mistakes or imagination. It's the same basic design since 1919, when the electric razor was invented. My invention improves on these factors because the razor/trimmer/edger/designer is more easier to use. It can be maneuvered around lips, mustaches, ears and beards in a more convenient way. And my designer can make more curvier/designer lines in one's hair, along with straight lines. There are more choices you can style one's hair.

1. The trimmer/edger/designer's housing is a slender cylinder about 7.5 inches in length and 1.5 cm in width, that narrows at the end like the shape of a pencil. The cylinder is a hard plastic or non-electrical conductive material. The top part of the narrow end has a hole in the end where razor-blade heads can be removed and replaced with the razor-blade head that's needed for a particular function.

2. The trimmer/edger/designer of claim 1, further comprising a pivot mechanism that is about 2.5 inches from the narrow top of the cylinder. A spring switch is on top of the cylinder, that controls the pivot mechanism, that allows the cylinder to pivot in one direction from 90-180 degrees. The spring switch, also, allows the pivot mechanism to pivot in different degrees between 90-180 degrees.

3. The trimmer/edger/designer of claim 2, further comprising a detachable razor-blade head guard (optional) that can be attached to an indentation that has a circumference around the outside of the cylinder that can attach a plastic guard from the indentation that is about 1.25 inches from the narrow end of the cylinder, just under the razor-blade head when placed in the hole designated for the blade head.

4. The trimmer/edger/designer of claim 3, further comprising a on-off push button that is at the bottom of the opposite end of the narrow end of the cylinder.

5. The trimmer/edger/designer of claim 4, further comprising a twist cap, which incorporates the on-off push button that is at the bottom end of the cylinder.

6. The trimmer/edger/designer of claim 5, further comprising of different size pivoting razor-blade heads starting from small heads where there circumference is 0.25 cm round . . . to pivoting razor-blade heads that has a circumference of 2 cm, and different sizes in between. The razor-blade head is in a circular configuration that has a safe guard over the razor blade it self to allow only the hairs, that are to be trimmed off, inside the slots provided for where the razor blade resides.

7. The trimmer/edger/designer of claim 6, further comprising two release buttons on the nose of the narrow end of the cylinder.
